(19) United States
(12) Patent Application Publication
(10) Pub. No.: US 2007/0098019 A1
(43) Pub. Date: May 3, 2007

(54) Automatic and selective backup system on a home network

(75) Inventors: Declan Patrick Kelly, Shanghai (JP); Philip Steven Newton, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/561,853

(22) PCT Filed: Jun. 22, 2004
(86) PCT No.: PCT/IB04/50960

§ 371 Date: Dec. 21, 2005

(30) Foreign Application Priority Data
Jun. 25, 2003 (EP) 03101865.8

(51) Int. Cl. H04J 1/02

(52) U.S. Cl. 370/493

(57) ABSTRACT

A method is proposed for selectively creating a backup of electronic content information on a home network. The method determines a relative importance of the content information; and stores the backup under control of the relative importance determined.

### FIELD OF THE INVENTION

The invention relates to managing content information on a network, especially a home network.

### BACKGROUND ART

Many people envision the home of the future containing a network of devices including a number of non-removable or stationary storage devices based on, e.g., hard-disk drives (HDD). The user can store content within this network and access it without worrying about the actual location. See, e.g., U.S. Ser. No. 09/568,932 (attorney docket U.S. 000106) filed May 11, 2000 for Eugene Shteyn and Ruud Roth for ELECTRONIC CONTENT GUIDE RENDERS CONTENT RESOURCES TRANSPARENT, herein incorporated by reference, and published as International Application WO0186948. This document relates to a data management system on a home network. The system collects data that is descriptive of content information available at various resources on the network. The data is combined in a single menu to enable the user to select from the content, regardless of the resource.

### SUMMARY OF THE INVENTION

It is expected that users will store their own content on this network, e.g., all their digital photos and camcorder recordings, etc., but also personal electronic documents relating to, e.g., insurance, tax, electronic copies of correspondence with relatives, friends, etc. If the user is going to rely increasingly more on the proper functioning of the hardware and software of the network, it is necessary that the installers and manufacturers provide some assurance that content data cannot readily get lost. A problem is that software and hardware components are known to fail unpredictably. For example, the mechanical parts of a HDD will wear out, resulting in a crash that leaves the stored data practically unrecoverable (too expensive for the normal user). Although hard-disk crashes are less frequent than in the past, they still occur and over the lifetime of a CE product (˜5 years), it is expected that a non-negligible number of customers will experience this problem. Losing content recorded from broadcast is not a big issue, as copies exist elsewhere. For example, the user could browse the Internet or a peer-to-peer (P2P) network of recorders in order to find another copy. For a brief discussion of P2P network architectures see, e.g., “Stretching The Fabric Of The Net: Examining the present and potential of peer-to-peer technologies”, Software & Information Industry Association (SIIA), 2001. However, losing one's own personal collection is a serious problem for the user and therefore for the device manufacturer and installers, as the latter parties will be held liable, if not in fact then in the perception of the end-user.

Therefore, the inventors propose to exploit the distributed nature of the home network to controllably store backups of content information important to the user. The term “backup” refers to one or more additional copies of the original content information, both the original and the copy being available on the network if all goes well. Preferably, the system will determine automatically which content is valuable and therefore needs to be backed up. The source and file format of the content could be taken into account to determine the content's value as perceived by the user.

More specifically, the invention provides a method of enabling to selectively create a backup of content information on a home network. The method comprises determining a relative importance of the content information to a user. Then the backup is stored on the home network under control of the relative importance determined. Preferably. the relative importance determined is associated with a particular storage mode relating to, e.g., on what device to have the content information stored and at what quality. The relative importance of the content information can be determined in a variety of ways. For example, the relative importance comprises depends on the source or the source medium that originally supplied the content, and/or on the file format.

In an embodiment of the invention, the backup creation process is controlled through software resident at the home network. The software is preferably adaptive in the sense that user interaction regarding to, e.g., manual overrides, renders the process more reliable from this user's perspective as the software has been learning from the user-preferences. Preferably, the home network comprises a UPnP home network in order for the software application to determine the various storage components on the network through the network's Registry. Other software architectures of the network are suitable as well if they provide an inventory of the capabilities available on the network.

In another embodiment, the backup process can be delegated to a server external to the home network, e.g., a server on the Internet. Backup copies could be automatically stored at storage external to the home network and leased from a service provider. Security is provided by means of, e.g., proper encryption and password protection.

Banks and other trusted financial institutions could provide this kind of service, as they have already been providing secure storage of physical objects (papers, jewelry, art, etc.).

Accordingly, the invention provides an archiving procedure to secure electronic content in view of, in particular, anticipated hardware or software problems. The invention enables to selectively and automatically distribute duplications of content among storage devices based on source and/or format and/or semantic analysis as a measure of the relative importance to the user.

### BRIEF DESCRIPTION OF THE DRAWING

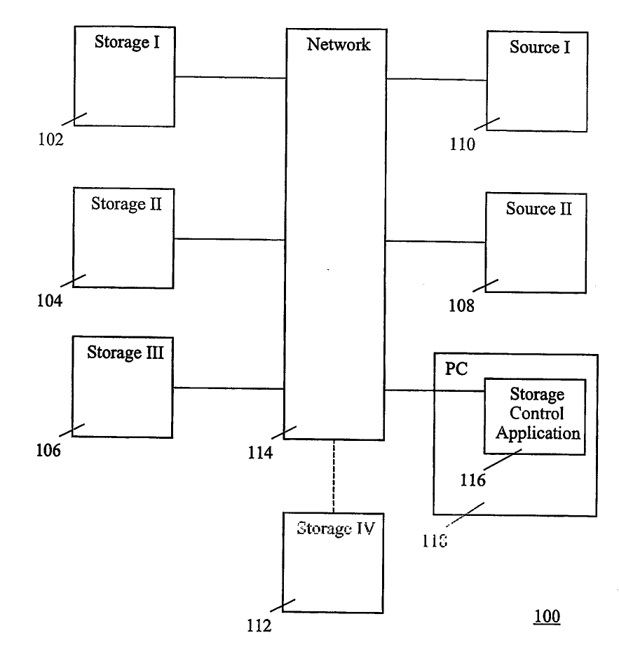

The invention is explained in further detail, by way of example and with reference to the accompanying drawing wherein FIG. 1 is a block diagram of a home network system in the invention.

### DETAILED EMBODIMENTS

The invention relates to exploiting the distributed nature of the home network system to store backups of important electronic content information. The system determines automatically which content information is valuable and therefore needs to be backed up. The source of the content information is one of the key ways to determine the value as perceived by the user.

The system classifies content information according to the value to the user. Possible categories are: High Value (e.g., the user would be very annoyed to lose this content information item as it is difficult to replace); Medium Value (the user would be annoyed to lose this content but it could be replaced); and Low Value (the user would not notice or care if he/she lost this content information item). Other categorization criteria are possible and a larger set of categories can be used. Issues are how the system determines into which category to put a specific content information item, and how the system treats the different categories.

Examples of issues taken into account in order to determine what is user-generated content are Source Medium (e.g., ROM/R/RW disc, DV tape, Solid State) and Source Format. Categorization is based initially on, e.g., the source and/or type of the content. Over time some content items may migrate to other categories due to the way they are being used or by explicit user choice. The following are some specific examples of categorizations. Content recorded from broadcast is categorized as Medium if the user programmed recording of this content. Content recorded from broadcast due to automatic recommendation by the system because of; e.g., a user profile, is classified as Low. Published content is classified as Medium, which can be determined from, e.g., the disc type, further discussed below. User-generated content is classified as High, and can be determined from, e.g., the source medium and the coding format. For example, content from DV (digital video) tape or Solid State can be taken to be user-generated content. This will typically never be published content. Conversely, content on a ROM disc is published content, so normally can be replaced if lost. For R/RW (rewritable) discs it is more difficult to determine whether it is the user's own content or content copied from publicly available material. One way to determine this is determining the format of the content on disc. For example, on a BD-RE disc (Blu-ray Disc format for optical re-writable disc) content stored in native DV format is clearly from a Camcorder. Content stored according to one of the broadcast formats is from broadcast However, content stored in Self Encoding Stream Format (SESF), a recording format used in Blu-Ray, is from an analog source so could be either broadcast or camcorder. In this ambiguous case, other methods are needed. Further details are being discussed below. Similarly, a DVD+RW disc containing a DVD-Video format is likely a copy of a published DVD disc. A DVD+RW containing a DVD+VR (VR stands for “video recorder”, DVD+VR is a recording standard for DVD) format is a recording from an analog source and therefore of ambiguous character. For details see further below. Similarly, for CDs with pictures, based on the naming and structure is should be possible to tell if they were published (will typically contain much more than just list of pictures) or generated from a digital camera/scanner.

There might be cases wherein it is not immediately clear from the source and/or the format whether or not the content information is user-generated. The system then needs to analyze the actual content to determine if it is published or user-generated (e.g., camcorder). Systems do exist that perform content analysis (e.g., chapter-detection or commercial detection). Camcorder recordings have different properties, for both audio and video, than published content so determining which is which is feasible using these conventional techniques.

This categorization is not foolproof but it does not need to be in order to be useful. It is also possible to tune these categorization algorithms to be over-cautious and so, when in doubt, choose the higher category. In addition, the degree of certainty of the categorization can be recorded along with the category. This enables, for example, to give priority to the more certain content items.

The actions the system takes based on the categorization are discussed next. Content categorized as High is backed up within the network so that, if the primary copy (original) is lost, a backup is available. Preferably, in order to save storage space, a lower bit-rate version is stored while taking care that the quality degradation is not obvious to the user when the content gets rendered. Content categorized as Medium is stored in a reliable area, e.g., on a HDD that is relatively new, so considered unlikely to fail. Content categorized as Low can be stored on older disks, possibly ones that already show bad sectors. Meta-data stored within the distributed system preferably indicates which content is backed up and in the case of lower bit-rate backups, indicates the primary and backup copies.

FIG. 1 is a block diagram of a home network system 100 in the invention. System 100 comprises a variety of components that comprise data storage capabilities. In the example shown, system 100 comprises a component 102 with a storage I, a component 104 with a storage II, and a component 106 with a storage III. System 100 further comprises components 108 and 110 that serve as data sources. System 100 also has a connection to an external server 112 that provides storage capacity external to home network 100, e.g., a server on the Internet under control of a trusted authority. Components 102-112 are capable of data communication via a data network 114.

For example, components 102-106 comprise a new HDD, an old HDD, and a DVD+RW drive, respectively, as parts of larger entities such as PCs, HDD-based jukeboxes, settop boxes equipped with a HDD or other CE apparatus. What is relevant here is that system 100 has distributed storage functionalities that are physically independent from one another and can be accessed via data network 114. Components 108-110 each comprise, for example, one of a camcorder, a digital tuner, a digital camera, a laptop or another mobile computing device, an MP3 player, etc.

When the user causes, e.g., source 110 to download new content information on network 100 in order to have it stored thereon, a storage control software application 116 on, e.g., a PC 118 determines the type of source. Application 116 does this by, for example, using UPnP. If source 110 is a UPnP device, then storage control application 116 can query source 110 for what kind of source it is and what kind of capabilities it has. This approach uses the device discovery mechanism of UPnP. The type of the file format is determined by, for example, using MIME types (MIME stands for Multimedia Internet Mail Extensions and is specified in RFC 2045 and RFC 2046) see also http://www.iana.org/assignments/media-types.

Storage control application 116 uses the UPnP device discovery mechanism in order to discover what UPnP devices there are on the network and what their capabilities are. Once it has gathered all the information about the devices it determines, based on the description of each device, whether it can use the device as a backup medium. Based on a pre-defined table used by the application 116, or a history log of user interactions, it knows which types of devices are appropriate to use as backups for particular types of content. The importance of the content it wants to backup is determined by using the source of the content, also using the device discovery mechanism and the mime type of the file. Say, for example, if a file has mime type “.jpg” and the source is a digital camera then the application categorizes this file as important. It then chooses an appropriate backup device such as a HDD. Note that a DVD+RW drive could in principle be used as well. However, using removable storage media on the network might be somewhat of a problem because it requires user interaction to ensure the correct disc is in the drive and, when retrieving the content, the user must put the same disc back in. In general for the proposed kind of automatic backup a fixed or stationary storage within the network would be used, typically an HDD, so it is automatic and transparent to the user.

As to the Universal Plug and Play (UPnP) software architecture, UPnP is an open network architecture that is designed to enable simple, ad hoc communication among distributed devices and software applications from multiple vendors. UPnP leverages Internet technology and extends it for use in non-supervised home networks. UPnP aims at controlling home appliances, including home automation, audio/video, printers, smart phones, etc. UPnP distinguishes between Control Points (CPs) and controlled devices (CDs). CPs comprise, e.g., browsers running on PCs, wireless pads, etc., that enable a user to access the functionality provided by controlled devices. UPnP defines protocols for discovery and control of devices by CPs. UPnP does not define a streaming mechanism for use by AudioVideo devices. Some of the discovery and control protocols are part of the UPnP specification while others are separately standardized by the IETF (Internet Engineering Taks Force). Interaction between CPs and devices is based on the Internet protocol (IP). However, UPnP allows non-IP devices to be proxied by a software component running on IP-compliant devices. Such a component, called Controlled Device (CD) proxy, is responsible for translation and forwarding of UPnP interactions to the proxied device. A UPnP device has a hierarchy of sub-devices with at the lowest level services. Both devices and services have standardized types. A device type determines the sub-devices or services that it is allowed to contain. A service type defines actions and state variables that a service is allowed to contain. State variables model the state of the device, actions can be invoked by a CP in order to change that state. The description of the state variables and the action is called the SCP (Service Control Protocol). A UPnP device provides a description of itself in the form of an XML document. This document contains, among other things, the service types that it supports. Optionally, a device may have a presentation server for direct UI control by a CP. Currently UPnP relies on AutoIP, which provides a means for an IP device to get a unique address in the absence of a DHCP server. UPnP defines a discovery protocol, based on UDP multicast, called SSDP (Simple Service Discovery Protocol). SSDP is based on devices periodically multicasting announcements of the services that they provide. An announcement contains a URL to which service actions are to be sent: the control server. In addition to that, CPs may query the UPnP network for particular device or services types or instances. UPnP relies on GENA (Generic Event Notification Architecture) to define a state variable subscription and change notification mechanism based on TCP. After a CP has detected a service it wants to use (via SSDP), it controls the service by sending SCP actions to the control server URL or querying for state variables. Actions are sent using HTTP POST messages. The body of these messages is defined by the SOAP (Simple Object Access Protocol) standard. SOAP defines a remote procedure call mechanism based on XML.

Incorporated herein by reference:

U.S. Ser. No. 09/374,694 (attorney docket PHA 23,737) filed Aug. 16, 1999 for Chanda Dharap for SEMANTIC CACHING, and published as International Application WO0113265. This document relates to the caching of resources based on the semantic type of the resource. The cache management strategy is customized for each semantic type, using different caching policies for different semantic types. Semantic types that can be expected to contain dynamic information, such as news and weather, employ an active caching policy wherein the resource in the cache memory is chosen for replacement based on the duration of time that the resource has been in cache memory. Conversely, semantic types that can be expected to contain static resources, such as encyclopaedic information, employ a more conservative caching strategy, such as LRU (Last Recently Used) and LFU (Least Frequently Used) that is substantially independent of the time duration that the resource remains in cache memory. Additionally, some semantic types, such as communicated e-mail messages, newsgroup messages, and so on, may employ a caching policy that is a combination of multiple strategies, wherein the resource progresses from an active cache with a dynamic caching policy to a more static caches with increasing less dynamic caching policies. The relationship between semantic content type and caching policy to be associated with the type can be determined in advance, or may be determined directly by the user, or could be based, at least partly, on user-history and profiling of user-interaction with the resources.

U.S. Ser. No. 09/519,546 (attorney docket U.S. 000014) filed March 6, 2000 for Erik Ekkel et al., for PERSONALIZING CE EQUIPMENT CONFIGURATION AT SERVER VIA WEB-ENABLED DEVICE, published as International Application WO0154406. This document relates to facilitating the configuring of CE equipment by the consumer by means of delegating the configuring to an application server on the Internet. The consumer enters his/her preferences in a specific interactive Web page through a suitable user-interface of an Internet-enabled device, such as a PC or set-top box or digital cell phone. The application server generates the control data based on the preferences entered and downloads the control data to the CE equipment itself or to the Internet-enabled device.

U.S. Ser. No. 09/616,632 (attorney docket U.S. 000184) filed Jul. 26, 2000 for Jean Moonen and Eugene Shteyn for SERVER-BASED MULTI-STANDARD HOME NETWORK BRIDGING, and published as International Application WO0209350. This document relates to a bridge in a home network for coupling first and second clusters of devices. The clusters have different software architectures. The bridge is connected to a server on the Internet This server offers a lookup service for some set of standards, and allows a bridge to locate and download the appropriate translation modules for allowing a device in the first cluster to interact with the second cluster.

1. A method of enabling to selectively create a backup of electronic content information on a home network, the method comprising:
determining a relative importance of the content information; and
storing the backup under control of the relative importance determined.

2. The method of claim 1, wherein the determining of the relative importance comprises determining a source of the content information.

3. The method of claim 1, wherein the determining of the relative importance comprises determining a file format of the content information.

4. The method claim 1, wherein the determining of the relative importance comprises determining a semantic attribute of the content information.

5. The method of claim 1, comprising determining a storage mode corresponding to the relative importance determined.

6. The method of claim 5, wherein the determining of the storage mode comprises determining a relevant one of multiple storage components available to the home network.

7. The method of claim 5, wherein the determining of the storage mode comprises determining whether to distribute multiple copies among different ones of multiple storage components available to the home network.

8. The method of claim 1, maintaining an overview of which content information has a backup copy.

9. Software for control of selective creation of a backup of electronic content information on a home network, the software being operative:
to determine a relative importance of the content information; and
to control storing of the backup under control of the relative importance determined.

10. The software of claim 9, wherein the relative importance depends on a source of the content information.

11. The software of claim 9, wherein the relative importance depends on a file format of the content information.

12. The software of claim 9, wherein the relative importance depends on a semantic attribute of the content information.

13. The software of claim 9, being operative to determine a storage mode corresponding to the relative importance determined.

14. The software of claim 13, being operative to determine the storage mode based on multiple storage components available to the home network.

15. The software of claim 13 being operative to determine whether to distribute multiple copies among different ones of multiple storage components available to the home network.

16. The software of claim 9, operative to maintain an overview of which content information has a backup copy.
